(19) United States
(12) Patent Application Publication
(10) Pub. No.: US 2011/0114770 A1
(43) Pub. Date: May 19, 2011

(54) ROLLER PRESS COMPRISING A GEAR COUPLING

(75) Inventor: Meinhard Frangenberg, Kurten (DE)

(73) Assignee: KHD HUMBOLDT WEDAG GMBH, Cologne (DE)

(21) Appl. No.: 12/996,913

(22) PCT Filed: Jun. 17, 2009
(86) PCT No.: PCT/EP2009/057543

§ 371 Date: Dec. 8, 2010

(30) Foreign Application Priority Data
Jun. 19, 2008 (DE) 20 2008 008 137.8

(51) Int. Cl. B02C 4/42; B02C 4/02

(52) U.S. Cl. 241/220

(57) ABSTRACT

The invention relates to a roller press comprising at least two rotatably mounted, counter-rotating rollers, separated by a roller nip, wherein at least one roller is driven by a gear. According to the invention, a coupling is situated between the gear and the driven roller or rollers. The advantage of the invention is that it provides a connection between the drive and the milling roller which permits simple, rapid disassembly and assembly of the connection between the shaft and the drive.

### BACKGROUND OF THE INVENTION

The invention relates to a roller press comprising at least two rotatably mounted, counter-rotating rollers separated by a roller nip, wherein at least one roller is driven by a gear.

In roller presses for the crushing of, for example, limestone, clinker, ores, minerals or builders' rubble, the individual pieces of the material to be ground are drawn into the roller nip of the roller press and are pressed and mutually crushed with the use of a high pressure. The pressure in the roller nip is here chosen, by appropriate pressure means which control the position of the rollers and thus maintain the pressure in the roller nip, at such a level that the material to be ground is pressed into so-called scabs. These pressed parts of crushed material are then broken up with low energy expenditure, whereupon the scabs disintegrate into finely crushed material. During operation of such roller presses, the surfaces of the rollers are subjected to high wear load due to the high pressing pressures and pressing forces, especially when an uncrushable foreign body, for example a lost hammer of an upstream hammer crusher, gets into the roller nip. But also the actual material to be ground severely wears down the surfaces of the rollers. Although measures are used in this context to protect the surfaces, such as, for example, the configuration of a material bed between hard bodies applied to the surface, wherein the material to be ground is pressed and crushed in the material bed, the grinding rollers of a roller press are subjected to very heavy wear, so that it is necessary to exchange the grinding rollers at regular intervals for reconstruction purposes.

In order to be able to remove the grinding rollers with a minimum of effort from the machine frame within which they are mounted, various measures are used. For instance, the machine frame is constructed such that individual frame parts can be swung down and thus aid the removal of a roller. To this end, the forces in the roller nip are absorbed by mechanisms placed between the rollers in order to keep the dimensioning of the frame as small as possible, which, in the case of mill weights of 50 t and far more, signifies a considerable alleviation of the workload.

In the disassembly of a roller press for roller changing purposes, the problem of the connection between drive and shaft nevertheless remains. Normally planetary gears are used, which planetary gears are fixedly connected to the shaft of the grinding rollers by shrinking-on. For the release of the gear-shaft connection, a shrink disk which is used for this purpose is heated and the gear can be pulled from the shaft. For reassembly, however, for instance with the replacement roller, a very precise alignment of the planetary gear or drive motor with the shaft is necessary, to enable the heated shrink disk to be guided exactly over the shaft for the fixed connection. In the case of very heavy drive machinery, this alignment work is laborious and is only practicable with appropriate auxiliary tools.

### SUMMARY OF THE INVENTION

The object of the invention is therefore to provide a connection between drive and grinding roller which allows a smooth and simple disassembly and reassembly of the shaft-drive connection.

The object according to the invention is achieved by the arrangement of a coupling between the gear and the at least one driven roller.

The arrangement of a coupling between shaft and drive allows a quick and easy release of the shaft-drive connection in the disassembly and subsequent assembly of the roller press in connection with the scheduled exchange of the grinding rollers.

It has proved advantageous if the shaft has a coupling disk which is shrunk onto the shaft. In addition, a fitting by flanging or welding on is also suitable. The coupling disk is enclosed for coupling purposes by detachable drivers, via which the torque is transmitted to the coupling disk and via the coupling disk to the shaft. For the release and restoration of the connection between drive and shaft, the necessary assembly effort is reduced to the fitting or removal of the drivers, so that a very elaborate and complex alignment of drive and shaft for connection by shrinkage is no longer necessary.

For the coupling of shaft and drive, two different arrangements are possible in principle, wherein in the first arrangement the coupling disk is disposed on the shaft and the drivers are fixedly disposed on the drive. In a second alternative, the drive has a coupling disk and the drivers are fixedly disposed on the shaft. Since the individual grinding rollers, as a wearing part, should be configured as simply as possible, it has proved advantageous if the coupling disk is fixedly disposed on the shaft of the grinding roller.

The drivers are realized such that, in the passive state and without application of a force, they fixedly enclose the coupling disk. For the release of the drivers, the drivers have a mechanism, for instance a simple screw connection or even an opening system, or an electromechanical or hydraulic system, wherein the electromechanical or the hydraulic system can be disengaged by appropriate transmission paths, such as sliding contacts or rotationally movable liquid seals, constantly, i.e. including during operation of the grinding roller. A disengagement of the coupling during operation has the advantage that the grinding roller has an emergency braking facility, for instance if the roller press has stuck fast and hence the drive could possibly suffer damage. Disengagement during operation is expedient, moreover, in order to be able to reduce the maximum torque transmitted by the coupling to an upper limit value. In the case of electrically or hydraulically activated drivers, a sensor which directly or indirectly registers the torque can influence the loosening and retightening of the drivers. Is also possible, however, to set the driver only so tight that, from a certain torque, the driver slips on the coupling disk.

If drivers which can constantly be disengaged remotely on an electromechanical or hydraulic basis are used, it is possible to configure the automatic release and refixing in a hysteresis. In this case, a driver becomes unfastened as soon as a maximum torque limit is exceeded, but the driver is only refixed once the necessary torque for the rotation of the driven grinding roller falls below a lower value. As a result of this hysteresis, a vibration of the coupling when a grinding roller sticks fast is avoided.

In a preferred embodiment of the invention, the coupling consists of a brake which is normally used in wind power plants. At the time of the invention which is represented here, brakes for wind power plants can be favorably obtained, so that their use in roller presses is economical. In these brakes, brake calipers sit with a corresponding brake pad on a brake disk. The brake disk here assumes the function of the coupling disk which is placed on the shaft of the grinding roller, and the brake calipers are fixedly connected to a drive disk lying opposite the coupling disk. The brake calipers are configured such that they are radially displaceable in small measure and maintain their rotary position by a fixing of the brake shoes on the brake disk. Since the brake calipers are fixedly connected to the drive disk, the torque is transmitted from the drive shaft via the brake calipers to the brake disk as the coupling disk.

The use of the brake calipers makes an extremely precise alignment of drive and brake disk, acting as a coupling disk, unnecessary, since a radial run-out arising from an inexact alignment is compensated during operation by the radial play of the brake calipers.

### BRIEF DESCRIPTION OF THE DRAWINGS

The invention is explained in greater detail below with reference to the following figures, wherein:

FIG. 1 shows a side view as a section through a drive-shaft coupling according to the invention,

FIG. 2 shows a top view of the coupling.

### DETAILED DESCRIPTION OF THE PREFERRED EMBODIMENTS

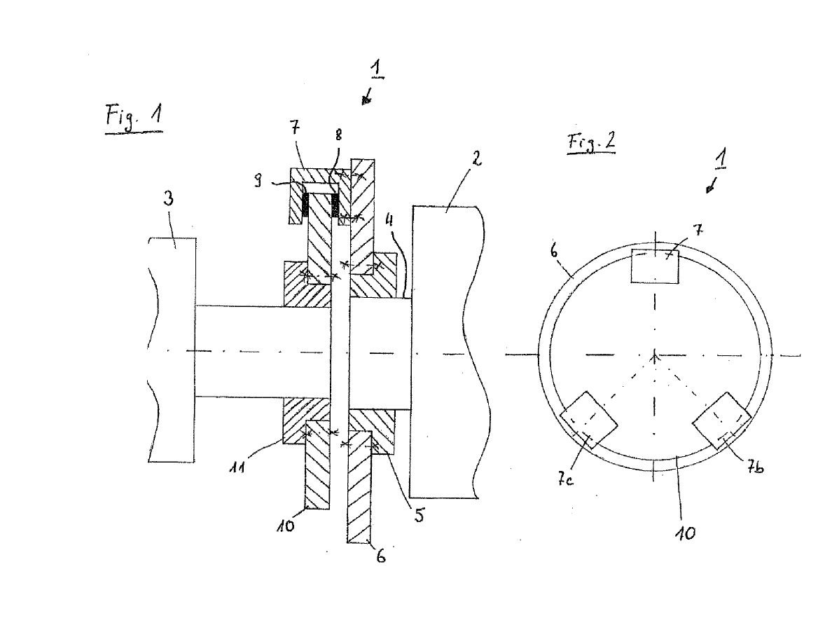

In FIG. 1, a coupling 1 according to the invention is represented, which coupling connects a drive 2 to the shaft 3 of a roller press. The drive 2 and the shaft 3 are precisely aligned in the initial assembly. Shrunk onto the drive shaft 4 of the drive 2 is a shrink disk 5, which serves to fixedly connect the drive 2 to the drive disk 6. On the flat end face facing the shaft 3 of the roller press, at least two drivers 7, here in the form of brake calipers of a brake system for a wind power plant, are mounted. The drivers allow a small radial play in order to compensate for radial run-outs in the connection between shaft 3 and drive 2. By a driver 7, which has two brake shoes 8, 9 and thus firmly grips a coupling disk 10, the torque of the drive 2 is transmitted to the shaft 3. The coupling disk 10, like the drive disk 6, is fastened to the shaft 3 by a shrink ring 11. In one particular embodiment of the invention, the drivers 7 have remotely operated disengagement means in order to decouple the drive during operation and, for instance, restrict the maximally transmissible torque.

In FIG. 2, a top view of the coupling 1 is represented, in which, in the foreground, the coupling disk 10 is enclosed by the three drivers 7, 7b and 7c distributed evenly around the periphery of the coupling disk 10. In the background of the picture, behind the coupling disk 10, the drive disk 6 is represented, on which drive disk the drivers 7, 7b and 7c are mounted such that they have a small radial play in order thus to compensate for a vertical play in the event of a misalignment between the two centers of rotation of the drive shaft 4 and shaft 3 of the grinding roller. In order to dissipate the strong build-up of heat upon partial loosening of the drivers, it is advantageous if the coupling disk 10 is a multidisk arrangement, comparable with a multidisk brake, and has an internal ventilation, as is known from disk brakes.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### REFERENCE SYMBOL LIST

1 coupling
2 drive
3 shaft
4 drive shaft
5 shrink disk
6 drive disk
7 driver
7b driver
7c driver
8 brake shoe
9 brake shoe
10 coupling disk
11 shrink disk

1-10. (canceled)

11. A roller press comprising at least two rotatably mounted, counter-rotating rollers separated by a roller nip, wherein at least one roller is driven by a gear, comprising:
a coupling arranged between the gear and the at least one driven roller.

12. The roller press as claimed in claim 11, wherein the coupling comprises a coupling disk enclosed by at least two drivers, wherein the drivers are configured detachably for the release of the coupling.

13. The roller press as claimed in claim 12, wherein the coupling disk is disposed on a shaft of the roller and the drivers are disposed on a corresponding disk of the gear.

14. The roller press as claimed in claim 13, wherein the coupling disk is one of shrunk onto the shaft and flanged onto the shaft.

15. The roller press as claimed in claim 13, wherein the drivers, in the passive state, fixedly enclose the coupling disk and have one of mechanical, electromechanical and hydraulic releasing means.

16. The roller press as claimed in claim 13, wherein the coupling comprises a brake unit for a wind power station, wherein a brake disk of the brake unit is shrunk onto the shaft of the roller and brake calipers of the brake unit are arranged as drivers on a drive disk shrunk onto the drive shaft of the gear and co-rotate with the drive disk, wherein the brake calipers firmly grip the brake disk and thereby couple the drive disk to the brake disk.

17. The roller press as claimed in claim 16, wherein on the drive shaft are arranged means for actuating the brake calipers, which means for actuating the brake calipers co-rotate with the drive shaft and the brake calipers.

18. The roller press as claimed in claim 11, wherein the coupling is configured as an overload coupling, wherein the drivers, if a predetermined torque transmission value is exceeded, abandon their coupling action and, if the torque transmission value is below a predetermined value, resume their coupling action.

19. The roller press as claimed in claim 18, wherein the value of the torque transmission above which the drivers abandon their coupling action is higher than the value of the torque transmission below which the drivers resume their coupling action.

20. The roller press as claimed in claim 16, wherein the brake disk is a multidisk brake.

21. The roller press as claimed in claim 20, wherein the multidisc brake has an internal ventilation.

22. A roller press comprising:
at least two rotatably mounted, counter-rotating rollers separated by a roller nip,
at least one of the rollers being driven by a gear, and
a coupling arranged between the gear and the at least one driven roller.
